(19) United States
(12) Patent Application Publication
(10) Pub. No.: US 2022/0000310 A1
(43) Pub. Date: Jan. 6, 2022

(54) APPLIANCE FOR PREPARING CHOPPED-UP FOOD COOKED IN THE PRESENCE OF FAT

(71) Applicant: Philippe Donfut, Sambreville (BE)

(72) Inventor: Philippe Donfut, Sambreville (BE)

(21) Appl. No.: 17/257,823

(22) PCT Filed: Jun. 28, 2018
(86) PCT No.: PCT/EP2018/067440

§ 371 Date: Jan. 4, 2021

(30) Foreign Application Priority Data
Jul. 4, 2017 (BE) 201705476

(51) Int. Cl. A47J 37/06; A47J 36/32; B26D 3/24

(52) U.S. Cl. CPC A47J 37/0641; B26D 3/24; A47J 36/32

(57) ABSTRACT

A household appliance for preparing food cooked in the presence of fat is described. The appliance includes: a container for receiving at least one raw food item; a preparation chamber; at least one cutting body designed to chop the raw food item into chopped-up parts and to transfer the chopped-up parts into the preparation chamber; a water-spraying device for spraying water onto the chopped-up parts inside the preparation chamber; evacuation means for evacuating the liquid water accumulated in the preparation chamber; means for spraying fat onto the chopped-up parts in the preparation chamber; heating means for drying and cooking the chopped-up parts in the preparation chamber; a controller connected to the water-spraying device, to the means for spraying fat and to the heating means, the controller being designed such that the food preparation appliance carries out a step of spraying water onto the chopped-up parts in the preparation chamber, a step of drying the chopped-up parts, a step of spraying fat over the chopped-up parts, and a step of cooking the chopped-up parts.

### FIELD OF THE INVENTION

The present invention relates to the technical field of household appliances for the preparation of cooked food items and in particular appliances designed to cook food items in the presence of fat.

The present invention relates to a household appliance intended to prepare cooked food items in chopped-up parts and in the presence of fat, such as crisps, from whole raw food item, such as whole potatoes.

### DESCRIPTION OF THE PRIOR ART

The document EP 1 781 155 discloses a household cooking appliance in the presence of fat in which food items are cooked using a hot-air-flow after being coated with fat that is spilled on the food items inside the cooking chamber. This appliance therefore differs from a conventional oil-bath fryer in that it performs dry cooking, i.e. cooking in which the food items are wet by a cooking medium, such as oil, but without being immersed or bathed in the said medium. This appliance therefore allows to control the amount of fat used for cooking and can also be configured to receive a removable, single-use fat cartridge, previously purchased commercially. However, the appliance can only receive in its cooking chamber food items that are ready for dry cooking, i.e. that have been washed and chopped-up appropriately beforehand. It is therefore not suitable for raw food items, such as whole potatoes, in order to prepare, for example, ready-to-eat crisps or fries.

The document US 2008/0206420 discloses a dry-cooking frying appliance in which hot air recirculation is used. Air is pumped into the cooking chamber and after being heated up, it is reintroduced into the cooking chamber. In addition, the heated air flow is conveyed to the cooking chamber via several ducts and through several outlet openings, so that several streams of hot air are generated and converge towards each other. These oppositely converging streams contribute to an excellent heat exchange with the food items, as they generate or favour, at their meeting point, the appearance of turbulence favourable to the transmission of heat.

The document U.S. Pat. No. 5,289,760 discloses an appliance for preparing ready-to-eat crisps or fries from potatoes. The appliance therefore comprises both a cutting chamber in which there is a cutting device, which is a rotating cutting blade, and a reservoir filled with frying oil for cooking the chopped-up parts, which are typically potato crisps or fries. The chopped-up parts in the cutting chamber are driven towards the reservoir filled with frying oil first by gravity and then by a rotating blade located under the cutting chamber and fixed to the shaft of rotation of the cutting device. The crisps or fries are then fried in an oil bath which has been preheated beforehand. This type of cooking uses a large amount of oil. This makes it difficult for the user to handle when filling the fryer, when moving it and especially when emptying it. This high-temperature cooking bath is also a source of risk of burns, either by splashing out of the appliance's bowl or due to clumsiness on the part of the user. This risk of burns or accidents is increased by the fact that such a large quantity of oil requires a relatively long preheating phase before the food items are placed in the bowl for frying. This can lead the user to forget about the oil bath during the pre-heating phase, with all the harmful consequences that this lack of supervision could cause. Moreover, in this type of appliance, it is not possible for the user to precisely control the quantities of fat used for cooking, which generally leads, at the end of the cooking process, to the obtaining of food items very rich in fat. Thus, food items cooked under the above-mentioned conditions are considered to generally have a pleasant taste, but are not recommended from a health point of view, as they are too impregnated with grease. Moreover, the oil-bath fryers are relatively expensive to use, as they require the regular purchase of a large quantity of oil (at least 1.5 to 2 litres of oil are generally required to fry 1 kg of fresh potato pieces). The user is therefore naturally led to save oil by reusing the same cooking bath several times, which is not very satisfactory from the point of view of hygiene and taste. Finally, heating such a large quantity of oil at high temperatures causes, on the one hand, the release of odours that can be particularly unpleasant and, on the other hand, the polymerisation of the oil, which makes cleaning the appliance difficult and inconvenient.

The document U.S. Pat. No. 4,251,895 discloses a cleaning system for a potato crisp production line. After being cut, the potato crisps are dropped into a water tray to remove starch residues and other unwanted particles from the surface of the freshly cut crisps. The crisps are then transported on a conveyor belt where they are further washed with a water-spraying device to remove the remaining particles and then passed through an air flow to remove the moisture from the surface of the crisps. The crisps then fall from the conveyor belt into an oil bath where the cooking process is carried out.

### SUMMARY OF THE INVENTION

A purpose of the present invention is to provide a compact household appliance for the preparation in a minimum amount of time of ready-to-eat cooked food items with advantageous taste properties, such as crisps, from whole and raw food items, such as whole potatoes.

Another aim is to provide a household appliance for the preparation of food items cooked in the presence of fat, in which the quantity and quality of fat used for cooking is controlled and with which the user can choose the seasoning he wishes to apply to his cooked food items.

Another purpose of the invention is to provide an appliance whose use requires only a minimum of user intervention.

The present invention is defined in the attached independent claim. The preferred embodiments are defined in the dependent claims.

The present invention relates to a household appliance for preparing food items cooked in the presence of fat comprising:
a container for receiving at least one raw food item;
a preparation chamber;
at least one cutting device configured to chop up said raw food item into chopped-up parts and to transfer said chopped-up parts into the preparation chamber;
a water-spraying device for spraying water on said chopped-up parts inside the preparation chamber;
evacuation means for evacuating the liquid water accumulated in the preparation chamber;
means for spraying fat on the chopped-up parts in the preparation chamber;
heating means for drying and cooking said chopped-up parts in said preparation chamber;
a controller connected to the water-spraying device, to the means for spraying fat and to the heating means, said controller being configured so that said preparation appliance carries out a step of spraying water on said chopped-up parts in the preparation chamber, a step of drying said chopped-up parts, a step of spraying fat on said chopped-up parts and a step of cooking said chopped-up parts.

According to an advantageous embodiment, the water-spraying device comprises a tank for receiving water, a pump and a spray nozzle.

According to an advantageous embodiment, the evacuation means comprise an evacuation port in the lower part of the preparation chamber for naturally evacuating liquid water that accumulates in the preparation chamber, the evacuation port opening into a water container for receiving the evacuated water.

According to an advantageous embodiment, the heating means are configured to generate a hot-air-flow in the preparation chamber. The heating means then preferably comprise at least one heating element for heating air in the vicinity of said heating element and at least one fan for directing the heated air into the preparation chamber.

According to an advantageous embodiment, the cutting device is configured to chop up said raw food item into chopped-up parts in the container, said container being located above the preparation chamber and being configured so that said chopped-up parts fall under the effect of the gravity into said preparation chamber.

According to an advantageous embodiment, the cutting device comprises a cutting plate rotatable by a shaft connected to an electric motor, said cutting plate being provided with through-holes defined by edges, said edges comprising cutting edges raised from the surface of the cutting plate, so as to chop up slices of food items exerting pressure against the upper surface of the cutting plate upon rotation of said shaft and to allow said slices to pass through the through-holes of said cutting plate. Such cutting devices are, for example, described in the document U.S. Pat. No. 5,289,760. Thrust means can then be provided to increase the pressure between the food item and the cutting plate.

According to an advantageous embodiment, the cutting device is operatively connected to the controller and the controller is configured to trigger the chopping step.

According to an advantageous embodiment, said preparation chamber comprises a removable reservoir for extracting the food items prepared by said appliance.

According to an advantageous embodiment, said preparation chamber comprises a portion made of a flexible material.

According to an advantageous embodiment, the controller comprises a storage memory in which different recipes including predetermined values for the heating power delivered by the heating means and the durations of the drying and firing steps are pre-recorded.

According to an advantageous embodiment, the appliance comprises a probe connected to the controller for measuring the temperature inside the preparation chamber, the controller being configured to adjust the heating power delivered by the heating means and the durations of the drying and cooking steps on the basis of the temperature information collected by said probe.

### BRIEF DESCRIPTION OF THE FIGURES

These and other complementary aspects of the invention will be explained in more detail by means of examples and by reference to the appended drawing:

FIG. 1 represents a household appliance for the preparation of cooked food items in chopped-up parts according to the invention in a functional configuration;

FIG. 2 represents a household appliance for the preparation of cooked food items in chopped-up parts according to the invention in a compact configuration for storage;

FIGS. 3a)-h) represent the different preparation steps carried out by a household appliance according to the invention;

The figure is not drawn to scale.

### DETAILED DESCRIPTION OF PREFERRED EMBODIMENTS

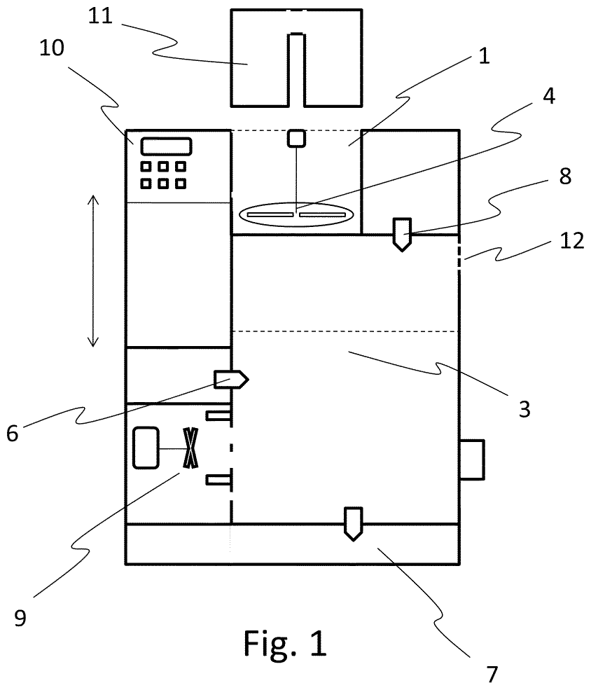

The invention therefore relates to a household appliance for preparing cooked food items in chopped-up parts and in the presence of fat. As shown in FIG. 1, this appliance comprises:
a container 1 for receiving at least one raw food item 2a, 2b;
a preparation chamber 3;
at least one cutting device 4 configured to chop up said raw food item 2a, 2b into chopped-up parts 5 and to transfer said chopped-up parts 5 to the preparation chamber 3;
a water-spraying device 6 for spraying water on said chopped-up parts 4 inside the preparation chamber 3;
evacuation means 7 for evacuating the liquid water accumulated in the preparation chamber 3;
means 8 for spraying fat onto the chopped-up parts in the preparation chamber 3;
heating means 9 for drying and cooking said chopped-up parts 5 in said preparation chamber 3;
a controller 10 connected to the water-spraying device 6, to the means 8 for spraying fat and the heating means 9, said controller 10 being configured so that said preparation appliance carries out a step of spraying water on said chopped-up parts 5 in the preparation chamber, a step of drying said chopped-up parts 5, a step of spraying fat on said chopped-up parts 5 and a step of cooking said chopped-up parts 5.

The appliance according to the invention thus makes it possible to prepare food items cooked in the presence of fat, such as potato crisps, from whole potatoes. The chopped-up parts 5 can in fact be thin slices having the typical dimensions of commercially available crisps. One of the advantages of the appliance according to the invention is that it allows a large number of the steps necessary for the production of fresh crisps from raw products such as whole potatoes to be carried out independently, in a minimum amount of time and without causing a large bulk for the user. In order to achieve this goal, the household appliance according to the invention implements a plurality of essential steps that result in the production of cooked food items such as ready-to-eat crisps.

The controller 10 of the appliance according to the invention is therefore advantageously an electronic controller capable of carrying out an electromechanical actuation of certain components of the appliance according to the invention and of processing information from any sensors or probes connected to it, such as a temperature probe in the preparation chamber. The controller 10 also advantageously includes an interface comprising a display screen and buttons so that the user can interact with the appliance according to the invention in order, for example, to select a recipe pre-recorded on the controller or to inform the controller of the nature of the food items introduced into the container or of the quality of the fat present in the means for spraying 8, the controller 10 being able to select a recipe or a set of suitable recipes from which the user is led to choose. By recipe, it is understood that a set of parameters affecting the taste properties and appearance of the food items produced by the appliance, which may include, for example, the temperature profile delivered by the heating means, the quantity of fat delivered during the spraying step, or the shape and dimensions of the chopped-up parts by the cutting device 4.

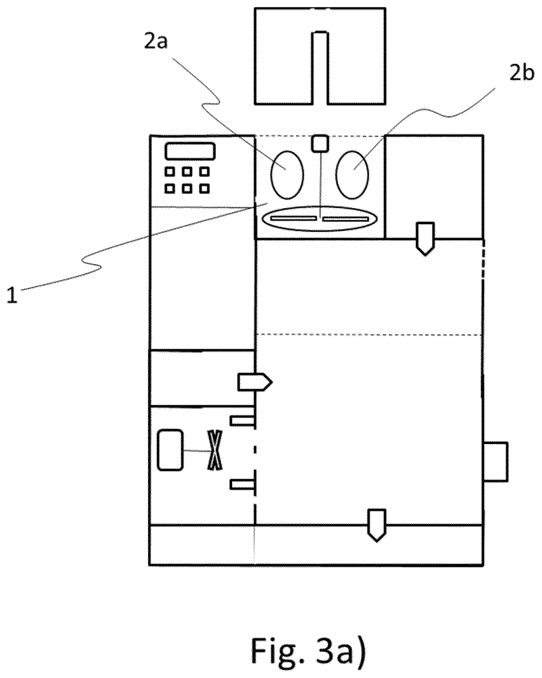

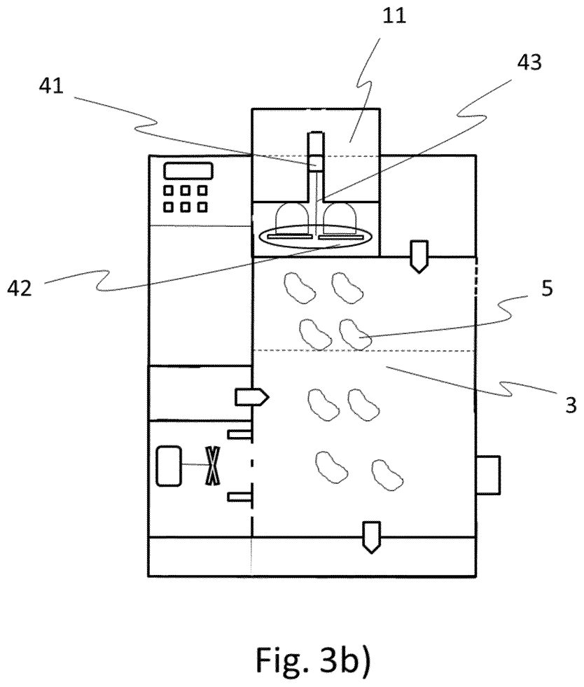

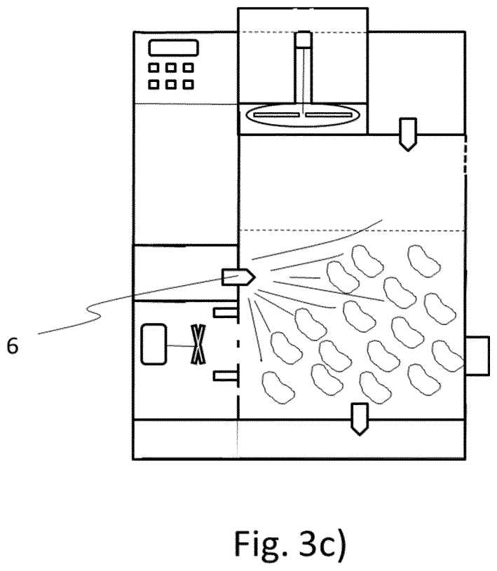

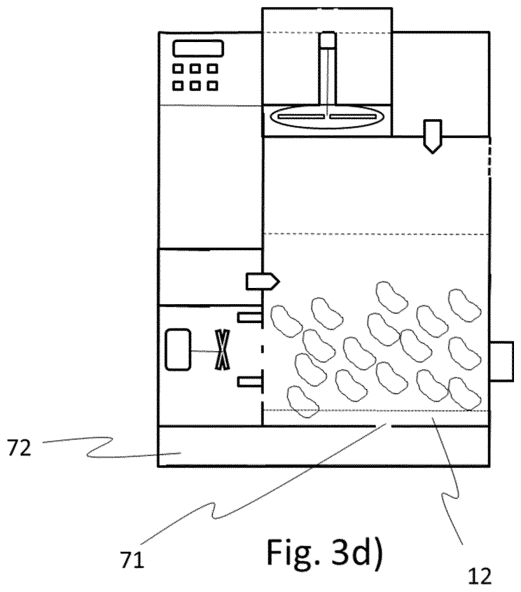

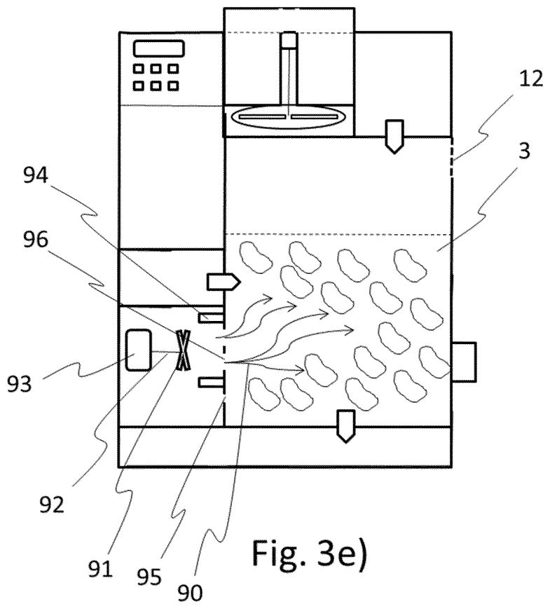

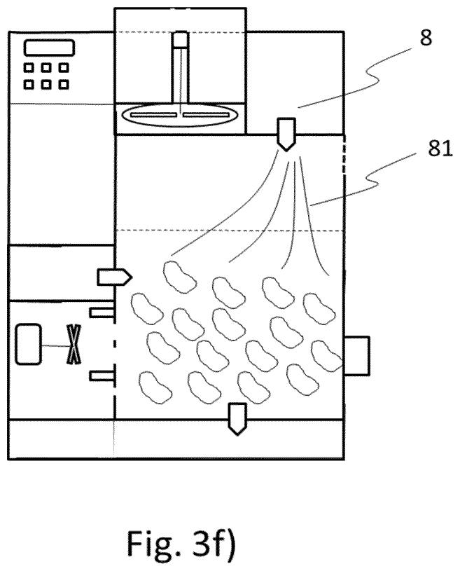

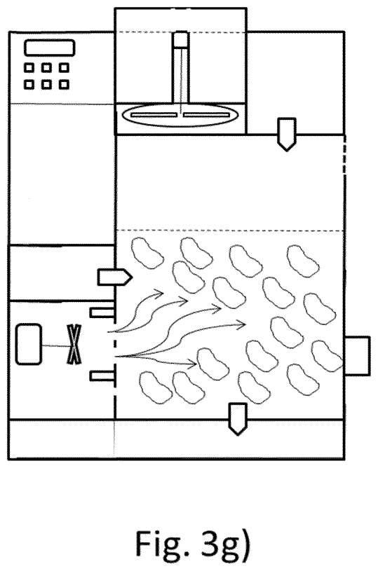

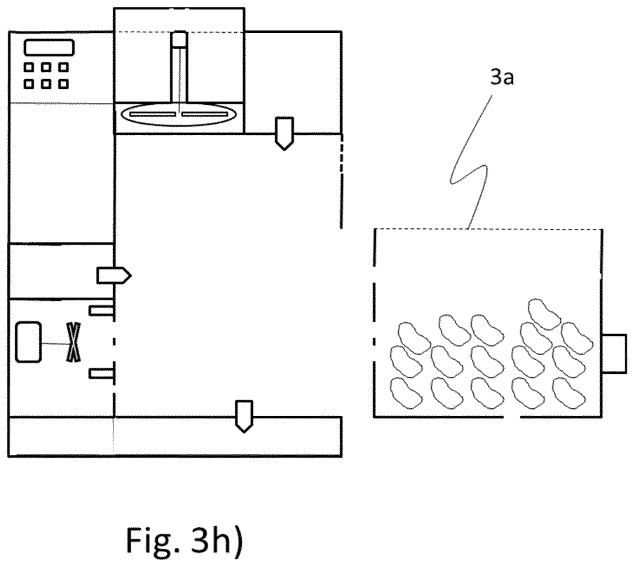

The different steps implemented by the appliance according to the invention are illustrated in FIGS. 3a)-h) in the particular case of using the appliance for the manufacture of potato crisps. It is important to note, however, that the same appliance or variants of it could be used to make crisps from other plants such as cassava, sweet potato, beet, apple, banana. The appliance could also be used to make products similar to crisps, such as potato fries.

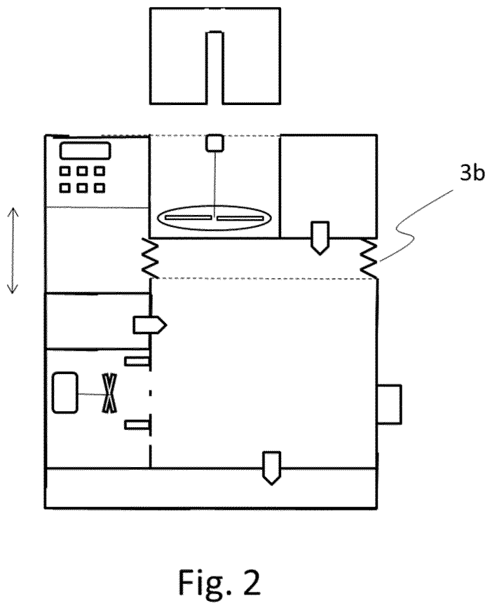

In the first step, illustrated in FIG. 3a), two potatoes 2a), 2b) are introduced into the container 1. In the embodiment as shown in FIGS. 1-3, the container 1 contains two housings, each of which can hold one potato. In other embodiments, the container can contain one housing or alternatively more than two housings.

After a food item has been introduced in the container 1, the cutting device 4 can be activated and will chop up the food item introduced and transfer it to the preparation chamber 3. The cutting device 4 therefore comprises cutting means which can be operated to chop up the food items introduced in the container into chopped-up parts and transfer them to the preparation chamber 3. The cutting device 4 can be a mechanical appliance operated by the user independently of the controller 10. The cutting device 4 can be operated by an electric motor or by a mechanical actuation operated by the user. In some embodiments, the chopping can be performed by a combined action of an electric motor directly triggered by the user, or via the controller 10 if the motor is operationally connected to it, and a manual action by the user, such as a push, for example. In the embodiment shown in FIG. 3b), the cutting device 4 is of the type described in the document U.S. Pat. No. 5,289,760 (and in particular shown in FIGS. 11-15 of said document), and consists of a motor 41 and a cutting plate 42 connected to the motor by a shaft 43, which allow thin slices 5 of potatoes to be chopped-up, having the typical dimensions of crisps. The cutting plate 42 is in fact provided with through holes defined by edges, among which there are cutting edges that are raised with respect to the surface of the cutting plate. These raised cutting edges make it possible to chop slices of a food item, in this case a potato 2a), 2b), when pressure is exerted against the upper surface of the cutting plate during the rotation of the shaft 43. If the weight of the food item is not high enough to exert sufficient pressure against the plate 42 to obtain a chop of the food item 2a), 2b), thrust means 11 can be used to increase the pressure between the food item 2a), 2b) and the cutting plate 4. These thrust means 11 can exert their action by their own weight, or by a mechanical actuation in translation exerted downwards by the user or by an electric motor connected to the controller 10. The through holes in the cutting plate 42 allow the slices 5 to pass through the cutting plate 42, and the slices 5 then fall under the action of gravity into the preparation chamber 3. If the cutting means 4 are functionally connected to the controller 10 and are therefore operated by the controller 10 after the user has started a preparation program, the appliance according to the invention carries out all the necessary steps for the preparation of food items cooked in the presence of fat, thus providing the user with optimum operating comfort.

Once all the chopped-up parts of the food item 2a), 2b) have been transferred to the preparation chamber, a water spraying step using the water-spraying device 6 is carried out. The water-spraying device 6 is advantageously operated by the controller 10 when the controller 10 has detected that the cutting step has been completed, for example by means of weight sensors in the container 1 or the preparation chamber 3, or, if thrust means 11 are provided, on the basis of a limit switch activated in the container 1 by thrust means 11 once all the raw food item has been transferred in chopped-up parts 5 in the preparation chamber 3. In another embodiment, the user can switch on the water spraying step himself from the controller 10 after the chopping step has been completed.

In addition to the obvious washing action of the chopped-up parts 5 by the water introduced into the preparation chamber 3, this water spray has an essential effect on certain food items freshly chopped-up by the cutting device 4 for the preparation of ready-to eat cooked food items. In particular, when the raw food item containing starch are introduced, such as potatoes 2a), 2b), the water introduced into the preparation chamber in the form of a spray effectively removes the starch particles accumulated on the surface of the freshly chopped slices. It has been observed that this step is necessary to achieve an optimal cooking and taste properties, in particular when preparing potato crisps using the appliance according to the invention.

According to an advantageous embodiment, the water-spraying device 6 comprises a pump, a spray nozzle and a water tank. The pump is advantageously connected to the controller 10, which therefore supervises its operation, i.e. its switching on and the spraying duration. The water tank must be dimensioned to be able to contain a volume of water necessary for the spraying phase carried out by the appliance according to the invention. Moreover, it is advantageously configured to be filled with water easily by the user. For example, it can be removable. The user can then remove it from the appliance and fill it with water before putting it back in place to carry out a preparation using the appliance.

Following the step of spraying water on the chopped-up parts 5, it is necessary to drain off the liquid water 12 that has accumulated in the preparation chamber 3, as shown in FIG. 3d). The particles removed from the surface of the chopped-up parts, which are in this liquid water 12, must be removed from the preparation chamber 3. In view of the upcoming cooking step, it has also been observed that it is highly advantageous to remove the liquid water 12 from the preparation chamber 3, as otherwise the liquid water 12 must be vaporised during the cooking process, which slows down the cooking process, is expensive from an energy point of view and does not provide satisfactory taste properties for the food item as they are then cooked for a significant amount of time in water vapour. For this purpose, the appliance according to the invention therefore comprises evacuation means 7 for evacuating the liquid water accumulated in the preparation chamber 3. These evacuation means 7 advantageously comprise an evacuation port 71 in the lower part of the preparation chamber 3, so as to naturally evacuate the liquid water 12 which accumulates in the preparation chamber 3, the evacuation port 71 opening into a water container 72 to receive the evacuated water. In addition, the evacuation port 71 may be fitted with means of closure, such as a shut-off valve, which may be in an open or closed state and may be operated by the controller 10. In this way, it is advantageous to be able to close the evacuation port before and/or after the liquid water evacuation step 12 from the preparation chamber 3. In particular, the evacuation port 71 will be advantageously closed during the subsequent steps of drying, fat spraying and cooking carried out by the appliance according to the invention, in order to thermally insulate the preparation chamber 3 and to prevent fat loss through the evacuation port. It is also important to note that if the evacuation port is sufficiently large, there will be no substantial accumulation of liquid water in the preparation chamber 3 because it will be evacuated as it is sprayed out during the water spraying step. The water container 72 advantageously includes means to drain it easily. For example, the water container 72 can be removed so that its contents can be easily poured into a sink. In other embodiments, the water container can include means for direct connection to a domestic sewage disposal system.

In order to reduce the humidity level in the preparation chamber 3 even further, the heating means 9 are activated by the controller 10 after the water spraying step. The heating means 9 are therefore the means which provide the essential heat input for drying and subsequent cooking of the food items in preparation chamber 3. The heating means can be of any type known to the person skilled in the art.

Advantageously, the heating means 9 are designed to generate a heating flux, which is oriented in such a way as to strike at least part of the food items in the preparation chamber 3 substantially directly. The term “heating flux” is used here to describe a directional heat beam with a positively controlled dynamic character, such as a hot-air-flow or a flow of infrared rays, as opposed, for example, to a simple natural convection effect which can be achieved by purely static heating.

Advantageously, as shown schematically in FIGS. 1-3, the heating means 9 are able to produce a hot-air-flow 90 and comprise mobile means of air deflection, such as a fan 91 connected by an shaft 92 to an electric motor 93. The fan 91 is therefore configured to generate an aeraulic flow during the rotation of the shaft 92, and the heating means 9 then advantageously comprise at least one heating element 94, for example of a resistive nature. This heating element 94 is advantageously positioned downstream of the fan 91, so as to transform the aeraulic flow into a heating flow. The fan 91 is advantageously a centrifugal fan and the hot-air-flow 90 it generates is advantageously a recirculated flow, i.e. the air heated by the heating means 9 is the air present inside the preparation chamber, taken to be heated through at least one inlet opening 95 and then returned to the preparation chamber 3 through at least one outlet opening 96. This hot air is cooled by contact with the food items, then drawn off again to be reheated, and so on. In an advantageous embodiment, a single electric motor can be used both by the heating means 9 to generate an air flow and by the cutting device 4 to perform its chopping action. In this case, a suitable mechanical system is implemented within the appliance according to the invention, comprising for example gears or transmission belts, in order to transmit the action of the motor to both the heating means 9 and the cutting device 4.

In an advantageous embodiment, the flow of heating air can be brought into the preparation chamber 3 by a piping system comprising several ducts so as to generate several converging streams of hot air. Such a configuration for the hot-air-flow contributes to excellent heat exchange with the food items because it generates turbulence at the meeting point of the different veins, which promotes heat transmission.

In the embodiment of the appliance shown in FIGS. 1-3, the inlet 95 and outlet 96 openings of the fan 91 are advantageously located on a side wall of the preparation chamber 3. The flow rate of the water-spraying device during the water spraying phase and the size of the liquid water evacuation means from the preparation chamber are selected so as to avoid an accumulation of liquid water whose level in the preparation chamber would exceed the height of the inlet 95 or outlet 96 of the fan 91. This configuration is advantageous because it prevents a substantial penetration of liquid water into the aeraulic circuit of the fan 91, which could then be detrimental to the latter. In an advantageous embodiment, the inlet and/or outlet port of the fan can be provided with closure means, such as shut-off valves, which can be in an open or closed state and which can be operated by the controller 10. The shut-off valves may then be in the closed position during certain preparation steps implemented by the appliance according to the invention, such as, for example, the water spraying step.

The purpose of the drying phase is therefore to reduce the humidity in the preparation chamber 3 below a certain threshold. It has indeed been observed that the subsequent step of spraying fat could not be carried out on chopped-up parts of food items with too high a moisture content, otherwise the taste properties of the food items prepared by the appliance according to the invention would not be satisfactory. The humidity threshold below which it is necessary to be at the time of spraying fat may vary according to the food items in the preparation chamber 3. Furthermore, the amount of heating energy to be supplied to the preparation chamber in order to fall below that threshold, and therefore the heating power delivered by the heating means 9 and the duration of the drying phase, depend on the quantity of water sprayed into the preparation chamber, the quantity of food items located in the preparation chamber and its specific water retention capacity. The moisture threshold to be reached and therefore the amount of heating energy to be supplied before the fat spraying phase for the optimisation of the taste properties are advantageously determined empirically depending on the quality and quantity of the food items introduced in the preparation chamber. In addition, for some food item it may be necessary not to exceed a certain temperature during this phase in order to preserve their taste properties. For example, it has been observed that in the case of the preparation of potato crisps, it is preferable not to exceed a temperature of 90° C. during the drying phase.

For food items drying, the preparation chamber 3, which is a substantially closed chamber, also comprises the advantage of a calibrated steam leakage to the outside. For this purpose, the means for calibrated steam leakage advantageously comprises at least one leakage port 12 communicating with the outside of the preparation chamber and dimensioned so as to:
effectively evacuate the water vapour from the preparation chamber 3 during the drying phase;
minimise the loss of heating energy by limiting the communication between the preparation chamber and the outside environment;

After the drying phase, a step of spraying fat, which is advantageously a viscous liquid such as oil and including possible aromatic additives, using the means 8 for spraying fat shown in FIG. 3f) is carried out by the appliance according to the invention. The means 8 for spraying fat comprise a tank for storing the fat and means for evacuating the fat 81 into the preparation chamber 3. In accordance with the invention, the fat is initially stored in the storage means and is transferred to the preparation chamber 3 under the action of the controller 10 at the end of the drying phase so that the chopped-up parts 5 are coated with fat for the cooking process. The step for spraying fat may also be carried out in several steps, i.e. it may be divided into several phases spaced in time during which a fraction of the total fat quantity to be delivered is sprinkled on the chopped-up parts 5. This implementation of spraying fat is particularly advantageous in the case where the chopped-up parts are in motion during the spraying of fat, for example under the action of a heating air flow delivered by the heating means 9, because it statistically allows a better distribution of the fat on the different chopped-up parts 5.

The means for spraying 8 are advantageously functionally connected to the preparation chamber 3 in order to be able to supply the preparation chamber with a predetermined quantity of fat by moving the fat from the storage means to and into the preparation chamber 3 under the action of the controller 10. The predetermined quantity of fat is advantageously a dose of fat corresponding to that required for coating the chopped-up parts 5 of food items in the preparation chamber 3. This predetermined quantity dispensed by the means for spraying 8 under the action of the controller 10 advantageously depends on the nature and quantity of the food items present in the preparation chamber and can be determined empirically with a view to obtaining the best taste properties for the food items prepared with the aid of the appliance according to the invention. The controller 10 can then advantageously be programmed to deliver during the spraying phase the appropriate dosage of fat according to the nature and quantity of the food items prepared by the appliance.

The information on the nature and quantity of the food items, in order to dispense an adequate dose of fat, may, for example, be entered by the user into the controller, via a display and buttons provided on the controller 10. The quantity of food items prepared could also be evaluated by means connected to the controller 10 to measure the mass or the volume of the food items introduced in the container 1 or of the chopped-up parts 5 of food items located in the preparation chamber 3 after the chopping phase. On the basis of the information on the nature and quantity of the prepared food items, the controller 10, which can advantageously include a storage memory, can then advantageously dispense a dose of fat according to recipes pre-recorded in this storage memory.

Advantageously, the fat storage tank is detachably mounted on the appliance according to the invention. This technical measure is particularly convenient for the user, who can easily manipulate the tank to fill it with fat, such as oil, for example. This technical measure also allows for interchangeability of the storage tank. This means that the user can have different storage tanks at his disposal, for example with different volume capacities. The user can therefore choose a suitable storage tank according to the quantity and/or quality of the food items he wishes to prepare.

Advantageously, the storage tank is designed for one-time use only, and may be disposable. In this case, the user can obtain a storage tank filled with fat on the market and connect it to the appliance. The user can thus benefit from particular oils or oil blends, possibly flavoured and/or particularly adapted to this or that food item. In this configuration, the spraying means include docking means in order to receive the storage tank and establish fluid communication between the contents of the storage tank and the preparation chamber 3.

The spraying means 8 are advantageously configured to efficiently dispense the fat in several directions into the preparation chamber 3 in order to coat as many chopped-up parts 5 as possible with a film of fat during the spraying phase. In this respect, the spaying means 8 are advantageously arranged to dispense the fat from the upper part of the preparation chamber 3 and advantageously comprise a pump and a spray nozzle to disperse the fat within the preparation chamber 3. The pump, which can also be a metering pump, is then advantageously connected to the controller 10, which thus supervises the start of the spraying phase and the quantity of fat dispensed. In the case of a disposable storage tank, the pump does not require any dosing means and is advantageously configured to dispense the entire fat content of the storage tank during the spraying phase.

When the tank is a disposable tank and the appliance is configured to dispense its entire contents during the spraying phase, the container 1 can also be equipped with sensors connected to the controller 10 to measure the mass or the volume of food items introduced in the container 1. The controller 10 can then inform the user if it detects a discrepancy between the quantity of food items introduced in the container 1 and the quantity of fat in the disposable tank.

In an advantageous embodiment, the means 8 for spraying fat may include means of spraying fat into the preparation chamber 3. In an advantageous embodiment, the water-spraying device 6 and the means 8 for spraying fat may consist of a single pump functionally connected to a water tank and a fat tank, respectively. In this embodiment, the pump thus comprises an inlet connected to the water tank and an inlet connected to the fat tank, these two tanks being advantageously located close to each other in the appliance according to the invention. Each of these inlets can be put in an open or closed position by means of shut-off means connected to the controller 10. Depending on the step implemented by the appliance according to the invention, namely the spraying of water or fat, the controller 10 selects the correct input of the pump to be opened. The use of a single pump for both functions allows a reduction in manufacturing costs and in the size of the appliance according to the invention. As far as the spraying of water and fat is concerned, it can be carried out using a single nozzle at the pump outlet. It may also be carried out using a spray nozzle dedicated to the spraying of water and another to the spraying of fat, in which case the pump then comprises two outlets, each of which may be put in the open or closed position by means of shut-off means connected to the controller 10.

After the fat has been sprayed, the cooking phase in the presence of fat is then carried out by the appliance according to the invention, as shown in FIG. 3g). From the point of view of the appliance, this phase is quite similar to the drying phase carried out before the spraying of fat, since it is advantageously carried out using the same heating means 9. The set points for the heating power delivered by the heating means 9, as well as the temperature to be reached or the duration of the cooking phase before stopping the heating means 9 can of course vary according to the quantity and quality of the food items prepared. The controller 10, which can advantageously include a storage memory, can then advantageously adapt the cooking parameters according to recipes pre-recorded in this storage memory.

It is important to note that even if in the illustrations 3a)-h) the heating means 9 have been shown in operation only at the drying 3e) and cooking 3g) steps, they may in practice be in operation during certain other steps implemented by the appliance according to the invention, including during all the steps. They can even be put into operation first, even before the food items chopping up phase, in order to pre-heat the preparation chamber 3. Furthermore, it has been observed that when the heating means 9 are configured to generate a hot-air-flow, it is advantageous to generate such a hot-air-flow during the water spraying and fat spraying phases, as the air flow then participates in a good distribution of water and fat, respectively, on all the chopped-up parts of the food items, by setting them in motion. In addition, if the cutting device 4 is functionally connected to the controller 10, the latter can be configured to start the chopping up, water spraying and drying steps simultaneously. In fact, once the food items have been introduced in the container 1, the chopping step is usually carried out very quickly, in a few seconds maximum. It is therefore not essential to allow for a time lag between the start of the chopping step and the water spraying step.

According to advantageous embodiments, the appliance according to the invention may include probes connected to the controller 10 to measure the temperature and/or humidity inside the preparation chamber 3. The heating power delivered by the heating means 9 and the duration of the drying and cooking steps can then be adjusted by the controller 10 on the basis of the temperature and/or humidity information collected by the said probes. In fact, the heating power delivered can then be adjusted in order to reach set temperatures or temperature ranges during the various steps of the appliance, such as pre-heating, drying, spraying with fat and cooking.

Once the cutting, water spraying, drying, fat spraying and cooking steps have been completed, the heating means 9 are stopped by the controller 10. At this point, the cooked food items in chopped-up parts can be removed from the appliance for consumption. For this purpose, it is advantageous to provide that the lower part of the preparation chamber 3 is a removable part 3a), advantageously with a handle. The cooked food items in chopped-up parts can then be easily removed from the appliance by removing the removable part 3a) from the appliance as shown in FIG. 3h).

Furthermore, from a structural point of view, the appliance body advantageously forms a C around the preparation chamber 3. The C-shaped appliance body then advantageously includes the means for spraying fat and the cutting device in its upper horizontal part and the liquid water evacuation means in its lower horizontal part. The heating means 9 and water spraying are then advantageously located in the vertical part of the C. The controller may be located on any part of the C. In this configuration, the preparation chamber 3 advantageously includes a part 3b) made of a flexible material and the appliance according to the invention then advantageously includes means for reducing the height of the vertical part of the appliance body. In this way, the height of the appliance according to the invention can be reduced when not in use, with a view to making it more compact, for example for easier storage.

1. A household appliance for preparing food items cooked in the presence of fat comprising:
a container for receiving at least one raw food item;
a preparation chamber;
at least one cutting device configured to chop up said raw food item into chopped-up parts and to transfer said chopped-up parts into the preparation chamber;
a water-spraying device for spraying water on said chopped-up parts inside the preparation chamber;
evacuation means for evacuating the liquid water accumulated in the preparation chamber;
means (8) for spraying fat on the chopped-up parts in the preparation chamber;
heating means for drying and cooking said chopped-up parts in said preparation chamber;
a controller connected to the water-spraying device, to the means for spraying fat and to the heating means, said controller being configured so that said preparation appliance carries out a step of spraying water on said chopped-up parts in the preparation chamber, a step of drying said chopped-up parts, a step of spraying fat on said chopped-up parts and a step of cooking said chopped-up parts.

2. The appliance according to claim 1, wherein the water-spraying device comprises a tank for receiving water, a pump and a spray nozzle.

3. The appliance according to claim 1, wherein the evacuation means comprise an evacuation port in the lower part of the preparation chamber for naturally evacuating liquid water which accumulates in the preparation chamber, the evacuation port opening into a water container for receiving the evacuated water.

4. The appliance according to claim 1, wherein the heating means are configured to generate a hot-air-flow in the preparation chamber.

5. The appliance according to claim 4, wherein the heating means comprise at least one heating element for heating air in the vicinity of said heating element and at least one fan for directing the heated air into the preparation chamber.

6. The appliance according to claim 1, wherein the cutting device is configured to chop up said raw food item into chopped-up parts in the container, said container being located above the preparation chamber and being configured so that said chopped-up parts fall under the effect of the gravity into said preparation chamber.

7. The appliance according to claim 6, wherein the cutting device comprises a cutting plate rotatable by a shaft connected to an electric motor, said cutting plate being provided with through holes defined by edges, said edges comprising cutting edges raised from the surface of the cutting plate, so as to chop up slices of food items exerting pressure against the upper surface of the cutting plate upon rotation of said shaft and to allow said slices to pass through the through holes of said cutting plate.

8. The appliance according to claim 7, comprising thrust means for increasing the pressure between the food item and the cutting plate.

9. The appliance according to claim 1, wherein the cutting device is operatively connected to the controller and the chopping up step is triggered by said controller.

10. The appliance according to claim 1, wherein said preparation chamber comprises a removable reservoir for extracting the food items prepared by said appliance.

11. The appliance according to claim 1, wherein said preparation chamber comprises a portion made of a flexible material.

12. The appliance according to claim 1, wherein the controller comprises a storage memory in which different recipes including predetermined values for the heating power delivered by the heating means and the durations of the drying and cooking steps are pre-recorded.

13. The appliance according to claim 1, comprising a probe connected to the controller for measuring the temperature inside the preparation chamber, the controller being configured to adjust the heating power delivered by the heating means and the durations of the drying and cooking steps on the basis of the temperature information collected by said probe.
